(19) United States
(12) Patent Application Publication
(10) Pub. No.: US 2024/0424669 A1
(43) Pub. Date: Dec. 26, 2024

(54) ROBOTIC PROCESS AUTOMATION (RPA) ACCELERATION OF TASKS WITH MACHINE LEARNING GENERATION OF NETWORK REQUESTS

(71) Applicant: INTERNATIONAL BUSINESS MACHINES CORPORATION, Armonk, NY (US)

(72) Inventors: Logan BAILEY, Atlanta, GA (US); Zachary A. SILVERSTEIN, Georgetown, TX (US); Hemant Kumar SIVASWAMY, Pune (IN); Robert Huntington GRANT, Marietta, GA (US)

(21) Appl. No.: 18/339,539

(22) Filed: Jun. 22, 2023

(51) Int. Cl. B25J 9/16

(52) U.S. Cl. CPC B25J 9/163; B25J 9/161

(57) ABSTRACT

Aspects of the present disclosure relate generally to robotic process automation (RPA) and, more particularly, to systems, computer program products, and methods of accelerating RPA tasks that interact with web pages with machine learning generation of network requests. For example, a computer-implemented method includes receiving, by a processor, plural runtime variables of a bot executing client-side web application code; generating, by the processor, a network request from a machine learning model given input of the plural runtime variables of the bot; and sending, by the processor, the network request generated from the machine learning model to the bot.

### BACKGROUND

Aspects of the present invention relate generally to robotic process automation (RPA) and, more particularly, to systems, computer program products, and methods of accelerating RPA tasks that interact with web pages with machine learning generation of network requests.

Deployment of robotic process automation projects have accelerated across many organizations that change a variety of manual tasks to digital tasks, saving time and money while enhancing productivity. RPA code is typically expressed in human-readable language of one or more keywords and a command or programmed actions that automates tasks typically performed by a user interacting with software applications. RPA robots (bots) access the user interface (UI) of software applications, such as web applications, to mimic keyboard and mouse interactions manually performed between a user and the UI of a software application to automate tasks. For instance, a human operator may enter data from an invoice into a spreadsheet of a financial system by copying the content of a cell and clicking a button. Such an interaction between the user and the UI of the software application may be defined as a payload or set of parameters that, for example, specifies the application and the value of a field. The bot may mimic the interactions between a user and the UI of software applications by executing UI commands that generate payloads defining such interactions. These payloads are then processed by the software application.

### SUMMARY

In a first aspect of the invention, there is a computer-implemented method provided. The computer-implemented method receives runtime variables of a bot executing client-side web application code and generates a network request from a machine learning model given input of the runtime variables of the bot. The computer-implemented method sends the network request generated from the machine learning model to the bot. Advantageously, the computer-implemented method of the present invention generates a network request from a machine learning model to allow bots to bypass execution of RPA commands that accelerates processing speed of a computing device executing RPA tasks.

In permissive aspects of the computer-implemented method, the plural runtime variables of the bot are input into the machine learning model and the generated network request is output from the machine learning model. These permissive aspects of the computer-implemented method of the present invention advantageously input plural runtime variables from the bot executing client-side web application code into the machine learning model that generates a network request as output to allow the bot to bypass execution of the RPA command that accelerates processing speed of a computing device executing the RPA task. Additionally, permissive aspects of the computer-implemented method determine if a confidence measure in the output of the generated network request exceeds a predetermined threshold. These permissive aspects of the computer-implemented method of the present invention advantageously determine if a confidence measure in the output of the generated network request exceeds a predetermined threshold that provides confidence that the output of the generated network request may be used to bypass execution of the UI commands by the bot to accelerate automation of the tasks.

In further permissive aspects of the computer-implemented method, the machine learning model comprises a recurrent neural network trained with plural associations of runtime variables and network requests to a web application. These permissive aspects of the computer-implemented method of the present invention advantageously generate a network request from a machine learning model that is a recurrent neural network that has the ability to dynamically learn from input sequential data such as the runtime variables and store what has been learned to predict the generation of network requests to allow the bot to bypass execution of the RPA command that accelerates processing speed of a computing device executing the RPA task. Additional permissive aspects of the computer-implemented method include the machine learning model comprises a Long Short Term Memory (LSTM) neural network trained with plural associations of runtime variables and network requests to a web application as well as the machine learning model comprises a Gated Recurring Unit (GRU) neural network trained with plural associations of runtime variables and network requests to a web application. These permissive aspects of the computer-implemented method of the present invention advantageously generate a network request from a machine learning model that is a LSTM neural network or a Gated Recurring Unit (GRU) neural network, each of which has the capability of learning long-term dependencies of input sequential data such as the runtime variables and store what has been learned to predict the generation of network requests to allow the bot to bypass execution of the RPA command that accelerates processing speed of a computing device executing the RPA task.

In yet further permissive aspects of the computer-implemented method, at least one of the plural runtime variables of the bot comprises a parameter of a robotic process automation command and the network request comprises a hypertext transfer protocol request with payload data of a selection of a user interface control in the client-side web application code. These permissive aspects of the computer-implemented method of the present invention advantageously facilitate input of a parameter of a robotic process automation command in a runtime variable of the bot executing client-side web application code into the machine learning model that generates a network request that is a hypertext transfer protocol request with payload data of a selection of a user interface control in the client-side web application code to allow the bot to bypass execution of an RPA UI command that accelerates processing speed of a computing device executing the RPA task.

In still further permissive aspects of the computer-implemented method, a request for generation of the network request is received from the bot executing client-side web application code. These permissive aspects of the computer-implemented method of the present invention advantageously facilitate the bot receiving the network request generated from a machine learning model given input of the runtime variables of the bot to allow the bot to bypass execution of an RPA command that accelerates processing speed of a computing device executing the RPA task. In permissive aspects of the computer-implemented method, the association of the plural runtime variables of the bot and the network request are stored in persistent storage. These permissive aspects of the computer-implemented method of the present invention advantageously facilitate storing the association of the plural runtime variables of the bot and the network request in persistent storage as training data from RPA executions to periodically train the machine learning model to generate a network request given input of the runtime variables of a bot executing client-side web application code.

In another aspect of the invention, there is a computer program product including one or more computer readable storage media having program instructions collectively stored on the one or more computer readable storage media. The program instructions are executable to receive runtime variables from executions of a bot executing client-side web application code, receive network requests from the executions of a bot executing client-side web application code, and store associations of the runtime variables and the network requests. The computer program product has further program instructions to train a machine learning model with the associations of the runtime variables and the network requests to generate a network request given input of runtime variables from an executing bot. Advantageously, the program instructions of the computer program product of the present invention trains a machine learning model to generate a network request given input of runtime variables from an executing bot to allow the bot to bypass execution of an RPA command that accelerates processing speed of a computing device executing an RPA task.

In permissive aspects of the computer program product, at least one of the runtime variables from the executing bot comprises a parameter of a robotic process automation command and at least one of the network requests comprises a hypertext transfer protocol request with payload data of a selection of a user interface control in the client-side web application code. These permissive aspects of the computer program product of the present invention advantageously facilitate input of a parameter of a robotic process automation command in a runtime variable of the bot executing client-side web application code into the machine learning model that generates a network request that is a hypertext transfer protocol request with payload data of a selection of a user interface control in the client-side web application code to allow the bot to bypass execution of an RPA UI command that accelerates processing speed of a computing device executing the RPA task.

Additionally, in permissive aspects of the computer program product, the machine learning model is selected from the group consisting of a recurrent neural network, a Long Short Term Memory (LSTM) neural network, and a Gated Recurrent Unit (GRU) neural network. These permissive aspects of the computer program product of the present invention advantageously train a machine learning model that is a recurrent neural network that has the ability to dynamically learn from input sequential data such as the runtime variables and store what has been learned to predict the generation of network requests to allow the bot to bypass execution of the RPA command that accelerates processing speed of a computing device executing the RPA task. These permissive aspects of the computer program product of the present invention also advantageously train a machine learning model that is a LSTM neural network or a Gated Recurring Unit (GRU) neural network, each of which has the capability of learning long-term dependencies of input sequential data such as the runtime variables and store what has been learned to predict the generation of network requests to allow the bot to bypass execution of the RPA command that accelerates processing speed of a computing device executing the RPA task.

In another aspect of the invention, there is a system including a processor set, one or more computer readable storage media, and program instructions collectively stored on the one or more computer readable storage media. The program instructions are executable to receive opt-in permission from a user of a client device and request generation of a network request from runtime variables of a bot executing client-side web application code of a web application. The program instructions are further executable to receive the network request generated from a machine learning model given input of the runtime variables of the bot and send the network request to the web application for processing. Advantageously, the program instructions of the system of the present invention receive a network request generated from a machine learning model given input of the runtime variables of the executing bot that sends the network request to the web application for processing, allowing the bot to bypass execution of RPA commands that accelerates processing speed of a computing device executing RPA tasks.

In permissive aspects of the system, the program instructions of sending the network request comprise bypassing execution of a robotic process automation command. These permissive aspects of the system of the present invention advantageously allow the bot executing client-side web application code of a web application to send the network request to the web application and bypass execution of an RPA command that accelerates processing speed of a computing device executing the RPA task. In further permissive aspects of the system, the program instructions are further executable to identify the runtime variables of the bot. These permissive aspects of the system of the present invention advantageously allow the bot executing client-side web application code of a web application to identify runtime variables that are associated with network requests and stored as training data from RPA executions to periodically train the machine learning model to generate a network request given input of the runtime variables of a bot executing client-side web application code that accelerates processing speed of a computing device executing RPA tasks.

In additional permissive aspects of the system, the machine learning model is trained with plural associations of runtime variables and network requests to generate the network request given input of the runtime variables of the bot. These permissive aspects of the system of the present invention advantageously facilitate a machine learning model trained to generate a network request given input of runtime variables from an executing bot to allow the bot to bypass execution of an RPA command that accelerates processing speed of a computing device executing an RPA task. Furthermore, in additional permissive aspects of the system, the machine learning model comprises a recurrent neural network trained with plural associations of runtime variables and network requests to the web application. These permissive aspects of the system of the present invention advantageously facilitate a trained recurrent neural network that has the ability to dynamically learn from input sequential data such as the runtime variables and store what has been learned to predict the generation of network requests to allow the bot to bypass execution of the RPA command that accelerates processing speed of a computing device executing the RPA task.

In yet further permissive aspects of the system, the program instructions are further executable to track plural network requests from client-side web application code sent to the web application. These permissive aspects of the system of the present invention advantageously allow the bot executing client-side web application code of a web application to track plural network requests from client-side web application code sent to the web application that are associated with runtime variables and stored as training data from RPA executions to periodically train the machine learning model to generate a network request given input of the runtime variables of a bot executing client-side web application code that accelerates processing speed of a computing device executing RPA tasks.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 depicts an illustration of an exemplary diagram of a workflow in accordance with aspects of the present invention.

FIG. 4 depicts an illustration of an exemplary diagram of a workflow in accordance with aspects of the present invention.

FIG. 5 shows a flowchart of an exemplary method in accordance with aspects of the present invention.

FIG. 6 shows a flowchart of an exemplary method in accordance with aspects of the present invention.

FIG. 7 shows a flowchart of an exemplary method in accordance with aspects of the present invention.

### DETAILED DESCRIPTION

Aspects of the present invention relate generally to robotic process automation (RPA) and, more particularly, to systems, computer program products, and methods of accelerating RPA tasks that interact with web pages with machine learning generation of network requests. More specifically, aspects of the present invention relate to methods, computer program products, and systems for receiving runtime variables of a bot executing client-side web application code, generating a network request from a machine learning model given input of the runtime variables of the bot, and sending the network request generated from the machine learning model to the bot. The bot executing the client-side web application code may bypass execution of an RPA command and instead send the network request generated from the machine learning model to a web application for processing. Embodiments of the present disclosure recognize the need for improvements in execution of RPA commands for a bot, such as UI commands, that can unfortunately involve long load times in practice for loading UI elements of web pages. Furthermore, the UI elements of many web pages merely serve oftentimes as an input form to operationally ensure all the required data is input for processing by the application. According to aspects of the present invention, the methods, systems, and computer program products described herein accelerate RPA tasks that interact with web pages with machine learning generation of network requests that provide payloads to allow bots to bypass execution of RPA commands such as UI commands and instead send the network request with payload data from the machine learning model to a web application for processing.

In embodiments, the methods, systems, and computer program products described herein associate runtime variables and network requests of executions of bot commands and train a machine learning model with the associations of the runtime variables and the network requests to generate a network request given input of runtime variables from an executing bot. The methods, systems, and computer program products of the present disclosure generate a network request from the machine learning model given input of runtime variables of a bot executing client-side web application code, and the bot bypasses execution of an RPA command and instead sends the network request with payload data generated from the machine learning model to a web application for processing.

Aspects of the present invention are directed to improvements in computer-related technology and existing technological processes for accelerating RPA tasks that interact with web pages with machine learning generation of network requests, among other features as described herein. In embodiments, the methods, computer program products, and systems may receive runtime variables of a bot executing client-side web application code, generate a network request from a machine learning model given input of the runtime variables of the bot, and send the network request generated from the machine learning model to the bot. The bot executing the client-side web application code may bypass execution of an RPA command and instead send the network request generated from the machine learning model to a web application for processing. Advantageously, the methods, computer program products, and systems described herein accelerate RPA tasks with machine learning generation of network requests that provide payloads to allow bots to bypass execution of RPA commands such as UI commands and instead send the network request with payload data from the machine learning model to a web application for processing. These are specific improvements in existing technological processes for accelerating RPA tasks with machine learning generation of network requests.

Implementations of the disclosure describe additional elements that are specific improvements in the way computers may operate and these additional elements provide non-abstract improvements to computer functionality and capabilities. As an example, the methods, computer program products, and systems describe a UI monitor module, network monitor module, bot monitor module, machine learning module, RNN training module, and recurrent neural network that associate runtime variables and network requests of executions of bot commands, train a machine learning model with the associations of the runtime variables and the network requests to generate a network request given input of runtime variables from an executing bot, generate a network request from the trained machine learning model given input of runtime variables of a bot executing client-side web application code, and send the network request with payload data generated from the machine learning model to a web application for processing. The additional elements of the methods, computer program products, and systems of the present disclosure are specific improvements in the way computers may operate to accelerate RPA tasks with machine learning generation of network requests.

It should be understood that, to the extent implementations of the invention collect, store, or employ personal information provided by, or obtained from, individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as RPA task acceleration with machine learning generation of network requests code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

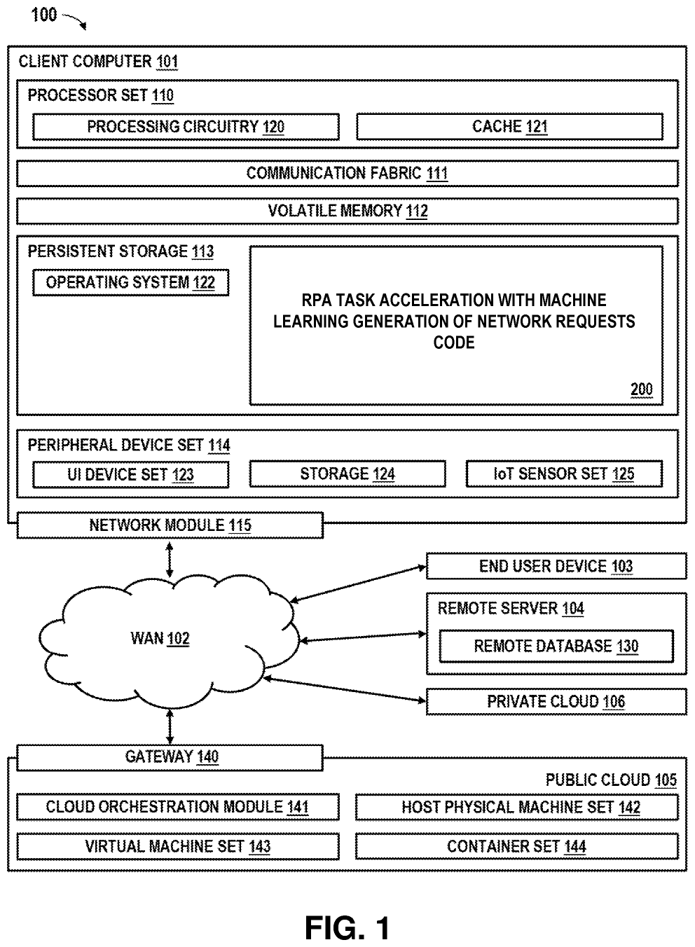

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

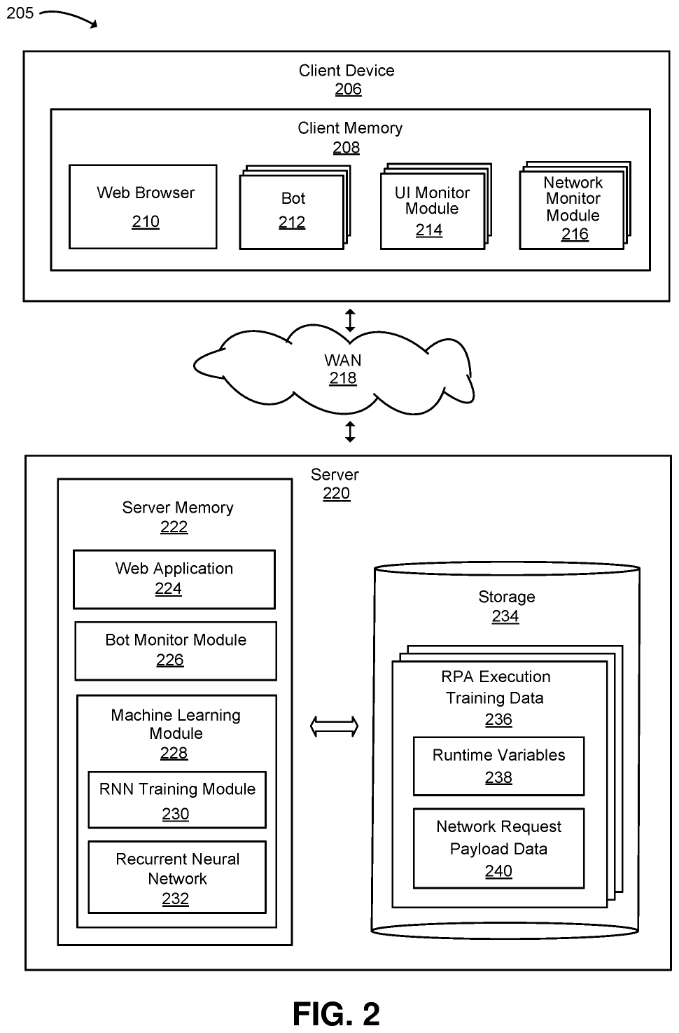

FIG. 2 shows a block diagram of an exemplary environment 205 in accordance with aspects of the present invention. In embodiments, the environment includes a client device 206 which may be a computer system such as end user device 103, described with respect to FIG. 1, with which computer 101 may communicate via network module 115 through WAN 102, each also described with respect to FIG. 1. In general, client device 206 runs bots 214 that automate tasks using web-based applications 212 and communicates over WAN 220 with server 222 (and backend applications 226).

Client device 206 has client memory 208 such as volatile memory 112 described with respect to FIG. 1. Client device 206 includes, in client memory 208, web browser 210 having functionality to execute client-side web application code and send Hypertext Transfer Protocol (HTTP) requests to and receive HTTP responses from a web application 224 hosted on web server such as server 220. Client device 206 also includes, in client memory 208, bot 212 having functionality to automate tasks using web-based applications such as web application 224, UI monitor module 214 having functionality to identify and runtime variables used in UI commands of bot 212 executing client-side web application code, and network monitor module 216 having functionality to track bot client-side network requests such as HTTP requests. In embodiments, the HTTP requests may be POST HTTP requests with payload data such as input data to UI elements of a web application, including, for example, single select, combo boxes, radio buttons, and other parameters. UI monitor module 214 and network monitor module 216 may respectively send the runtime variables and client-side network requests with payload data to server 220 for training a machine learning model to learn the association of runtime variables and network requests with payload data in order to generate network requests with payload data from runtime variables and directly send the network request to the web application. In this way, the bot may bypass execution of the UI commands and accelerate automation of the tasks by generating the network requests with payload data and sending the generated network requests to the web application.

In embodiments, web browser 210, bot 212, UI monitor module 214, and network monitor module 216, each may include routines, programs, objects, components, logic, data structures, and so on that perform particular tasks or implement particular data types used to carry out the functions and/or methodologies of embodiments of the invention as described herein. These modules are executable by the processing circuitry to perform the inventive methods as described herein. Client device 206 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the invention, environment 205 of FIG. 2 also includes server 220 which may communicate with client device 206 over WAN 218, which may be a WAN such as WAN 102 described with respect to FIG. 1. Server 220 may be a computer system such as a computer 101 described with respect to FIG. 1 with which end user devices 103 and remote servers 104, each also described with respect to FIG. 1, may communicate over a network such as WAN 102 described with respect to FIG. 1. In general, server 220 supports services for hosting web application 224, receiving HTTP requests from and sending HTTP responses to client device 206, and receiving runtime variables and client-side network requests with payload data for training a machine learning model to learn the association of runtime variables and network requests with payload data in order to generate network requests with payload data from runtime variables.

Server 220 has server memory 222 such as volatile memory 112 described with respect to FIG. 1. Server 220 includes, in memory 222, web application 224 having functionality to process HTTP requests received from web browser 210 in embodiments, bot monitor module 226 having functionality to receive and store in storage 234 runtime variables and client-side network requests with payload data, and machine learning module 228 having functionality to receive requests with runtime variables to generate network request with payload data. The machine learning module 228 may include RNN training module 230, having functionality to train recurrent neural network 232 with RPA execution training data including runtime variables and network requests with payload data to learn the association of runtime variables and network requests, and recurrent neural network 232 having functionality to receive runtime variables and generate network requests with payload data.

In embodiments, web application 224, bot monitor module 226, machine learning module 228, and RNN training module 230, each may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The server 220 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the present invention, FIG. 2 also shows a block diagram of storage 234 which may be storage such as storage 124 of computer 101 described with respect to FIG. 1. Storage 234 may store RPA execution training data 236 in files which may include runtime variables 238 paired with network request payload data 240 of bot 212.

In embodiments, runtime variables used in UI commands of bot 212 executing client-side web application code and corresponding client-side network requests such as POST HTTP requests with payload data may be used to train the recurrent network model to learn the association of runtime variables and network requests with payload data. The trained recurrent neural network may be used to generate network requests with payload data from the runtime variables which may be directly sent from the bot 212 to the web application 224 and bypass execution of the UI commands by the bot 212 to accelerate automation of the tasks.

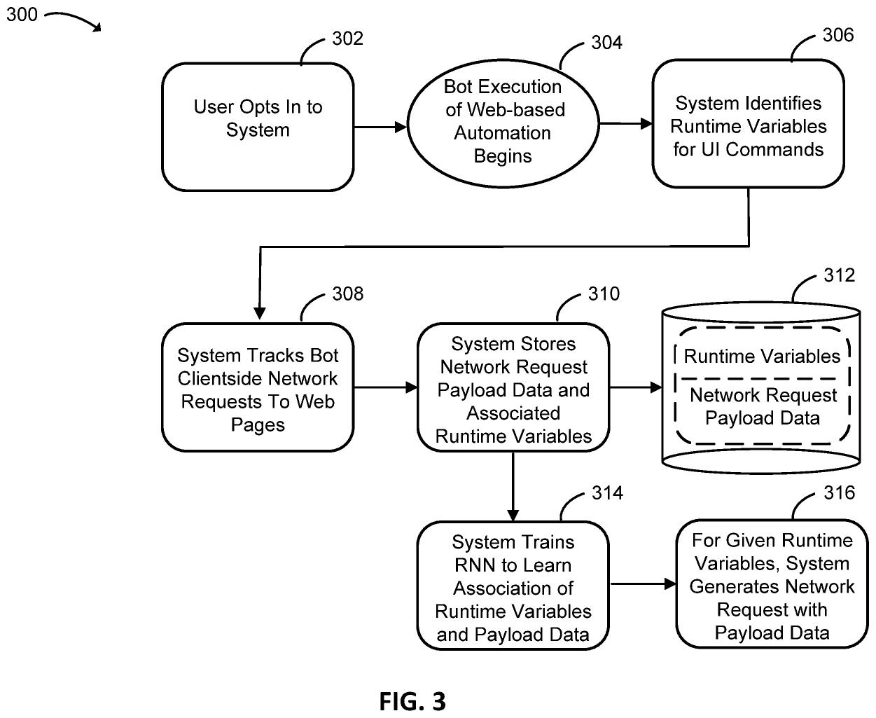

FIG. 3 depicts an illustration of an exemplary diagram of a workflow for machine learning of association of runtime variables and network requests to generate network requests for UI commands in accordance with aspects of the present invention. In particular, the process flow diagram of FIG. 3 illustrates the process flow environment 300 in embodiments to capture runtime variables and network requests during executions of bot tasks and train a machine learning model to learn the association of runtime variables and network requests to accelerate RPA tasks by generating network requests for UI commands. At reference numeral 302, the user of the system opts in to use the exemplary modules of the system, such as UI monitor module 214, network monitor module 216, bot monitor module 226, machine learning module 228, RNN training module 230, and recurrent neural network 232, each described with respect to FIG. 2. The system begins execution of a bot performing web-based automation at 304 that includes in embodiments execution of UI commands that input data into a UI of client-side web application code. For instance, the input data may be the selection of a UI control such as a single select control, combo boxes, radio buttons, and other type of UI control.

At reference numeral 306, the system identifies runtime variables for execution of the UI commands. In embodiments, the bot may be instrumented to send runtime variables and parameters of UI commands to UI monitor module 214 described with respect to FIG. 2. The UI monitor module 214 may alternatively obtain runtime variables and parameters from the runtime environment in embodiments, for instance, by invoking a runtime environment command. At 308, the system tracks bot client-side network requests to automated web pages of web applications. In embodiments and as described with respect to FIG. 2, the network monitor module 216 may track network communications between the web browser 210 executing on the client device 206 and the web application 224 executing on the server 220, including POST HTTP requests with payload data such as input data for a UI control. At 310, the system stores the network request with payload data and the associated runtime variables in persistent storage. For example, the UI monitor module 214 and the network monitor module 216, each described with respect to FIG. 2, may respectively send the runtime variables and the network requests to the bot monitor module 226, also described with respect to FIG. 2, that may associate and store the runtime variables and network request received in persistent storage as illustrated at reference numeral 312.

At reference numeral 314, the system trains a recurrent neural network (RNN) to learn the association of runtime variables and network request with payload data. The generation of the network request with payload data is learned from the association with runtime variables by machine learning that allows the learned information of the association of runtime variables to persist for predicting the generation of the network request. In particular, recurrent neural networks (RNNs) are a type of neural network used for learning information that persists for predicting patterns. Typically, RNNs are comprised of a chain of cells, each with repeating modules of neural network. In a standard RNN, the repeating module may be a single network layer, and the standard RNN can output a prediction of a pattern as a vector of information about the entire input sequence. Accordingly, the RNN has the ability to dynamically learn from input sequential data such as runtime variables and store what has been learned to predict the generation of network requests.

More particularly, the Long Short Term Memory (LSTM) neural network is a type of RNN capable of learning long-term dependencies of input sequential data. The repeating module of an LTSM has four interacting neural network layers that are regulated by gates that control and filter the amount of persisted information and updated information that are output by each cell in the chain. Those skilled in the art should appreciate that a LSTM neural network or other RNN may be trained, including gated recurrent unit (GRU), to learn the association of runtime variables and network request with payload data in embodiments.

Continuing with the workflow illustrated in FIG. 3, the system generates a network request for given runtime variables using the trained RNN at 316. Accordingly, the runtime variables and network requests for executions of the bot automating tasks are tracked, associated, stored and used to train a RNN for machine learning of the association of runtime variables and network requests to generate network requests from runtime variables for UI commands.

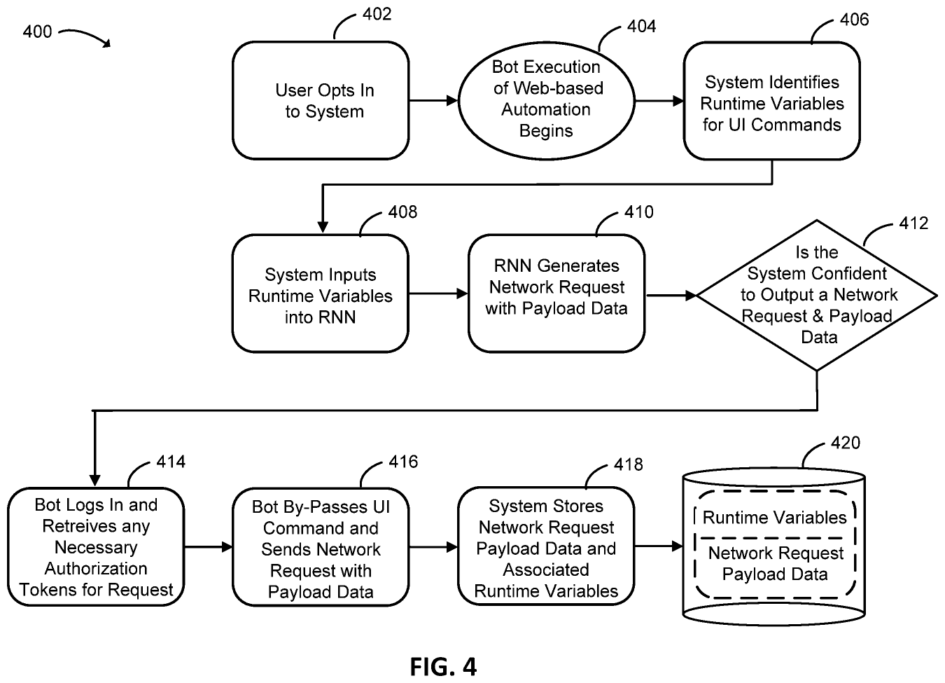

FIG. 4 depicts an illustration of an exemplary diagram of a workflow for accelerating RPA tasks with machine learning generation of network requests for UI commands in accordance with aspects of the present invention. In particular, the process flow diagram of FIG. 4 illustrates the process flow environment 400 in embodiments to capture runtime variables for UI commands and generate network requests for UI commands with machine learning. At reference numeral 402, the user of the system opts in to use the exemplary modules of the system. The bot is updated to include the addition of execution code that requests generation of a network request with payload data from the system prior to executing UI commands with parameters. The system begins execution of a bot performing web-based automation at 404 that includes in embodiments execution of UI commands that input data into a UI of client-side web application code. At 406, the system identifies runtime variables for UI commands. As part of the execution code included in the bot that requests generation of a network request with payload data from the system prior to executing the UI command in embodiments, the bot may identify runtime variables for the UI commands.

At reference numeral 408, the system inputs the sequence of runtime variables into the trained recurrent neural network and the recurrent neural network generates a network request with payload data at 410. In embodiments, the recurrent neural network may be a standard RNN, a LSTM neural network or other type of RNN, including gated recurrent unit (GRU), trained to learn the association of runtime variables and network request with payload data. At 412, the system determines whether a confidence measure of the association of the runtime variables and the output sequence of a network request with payload data exceeds a predetermined threshold. For instance, the recurrent neural network may provide a probability that the runtime variables input into the trained recurrent neural network predict the output sequence of the network request with payload data generated by the recurrent neural network. If the confidence measure exceeds the predetermined threshold, then the system may use the output sequence of the network request with payload data generated by the recurrent neural network to bypass execution of the UI commands by the bot to accelerate automation of the tasks. Otherwise, the bot may execute the UI command which will generate and send the network request with payload data to the web application for processing.

At reference numeral 414, the bot may log in and retrieve any authorization tokens necessary to be sent with the network request to the server hosting the web application for processing. For instance, in token-based authentication of network requests, a javascript object notation (json) web token may be sent with the network request to the server hosting the web application to verify the authenticity of each network request. At 416, the bot bypasses execution of the UI command and directly sends the network request with payload data generated by the RNN to the web application for processing along with any necessary authorization tokens. At 418, the system stores the network request with payload data and associated runtime variables in persistent storage as illustrated at reference numeral 420. The stored network request with payload data and associated runtime variables may be used with other stored network requests and associated runtime variables to periodically train the RNN. In this way, the bot may bypass execution of the UI commands and accelerate automation of the tasks by generating the network requests with payload data and sending the generated network requests to the web application.

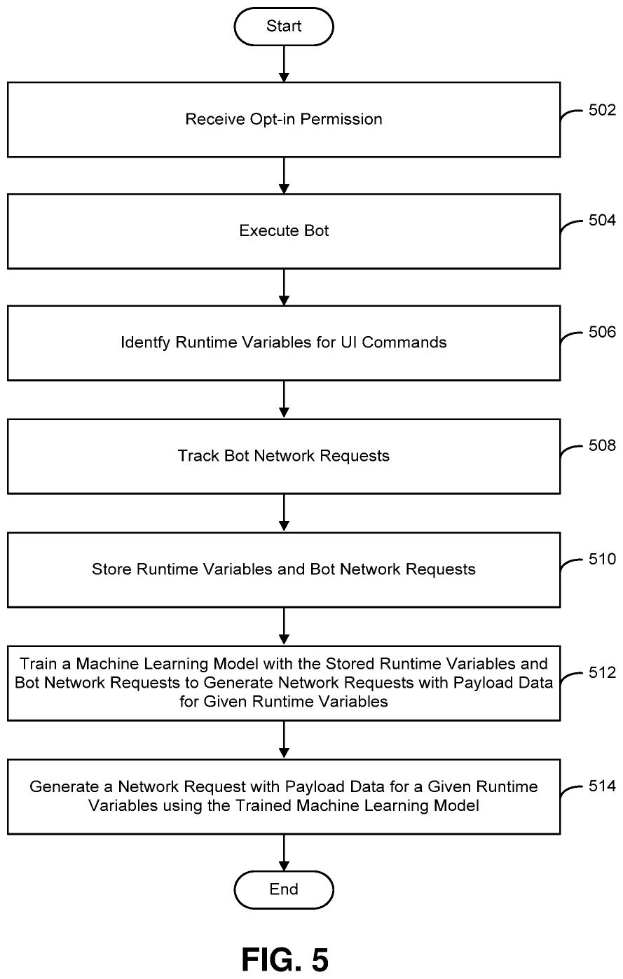

FIGS. 5-7 show flowcharts and/or block diagrams that illustrate the architecture, functionality, and operation of possible implementations of systems, methods, and computer program products according to various embodiments of the present invention. As noted above with respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time. And some blocks shown may be performed and other blocks not performed, depending upon the functionality involved.

FIG. 5 shows a flowchart of an exemplary method in accordance with aspects of the present invention. Steps of the method may be carried out in the environment of FIG. 2 and are described with reference to elements depicted in FIG. 2. In particular, the flowchart of FIG. 5 shows an exemplary method for machine learning of association of runtime variables and network requests to generate network requests for UI commands in accordance with aspects of the present invention.

At step 502, the system receives opt-in permission to use the exemplary modules of the system from a user. For example, a user of client device 206 described with respect to FIG. 2 may provide opt-in permission to use the exemplary modules of the system. In embodiments, and as described with respect to FIG. 2, client device 206 receives opt-in permission to use the exemplary modules of the system from a user.

At step 504, the system executes a bot performing web-based automation. For example, the bot performing web-based automation may include in embodiments execution of UI commands that input data into a UI of client-side web application code. For instance, the input data may be the selection of a UI control such as a single select control, combo boxes, radio buttons, and other type of UI control. In embodiments, and as described with respect to FIG. 2, bot 212 executes in client memory 208 of client device 206.

At step 506, the system identifies runtime variables for a UI command. For instance, the bot may be instrumented to send runtime variables and parameters of UI commands to UI monitor module 214 described with respect to FIG. 2. The UI monitor module 214 may alternatively obtain runtime variables and parameters from the runtime environment in embodiments, for instance, by invoking a runtime environment command. In embodiments, and as described with respect to FIG. 2, UI monitor module 214 identifies runtime variables for a UI command.

At step 508, the system tracks network requests from client-side web application code sent to server-side web applications. In embodiments and as described with respect to FIG. 2, the network monitor module 216 may track network communications between the web browser 210 executing on the client device 206 and the web application 224 executing on the server 220, including POST HTTP requests with payload data such as input data for a UI control. In embodiments, and as described with respect to FIG. 2, the network monitor module 216 tracks network requests from client-side web application code sent to server-side web applications.

At step 510, the system stores the network request with payload data and the associated runtime variables in persistent storage. For example, UI monitor module 214 and network monitor module 216, each described with respect to FIG. 2, may respectively send the runtime variables and the network requests to bot monitor module 226, also described with respect to FIG. 2, that may associate and store the runtime variables and network request received in persistent storage. In embodiments, and as described with respect to FIG. 2, bot monitor module 226 stores the network request with payload data and the associated runtime variables in persistent storage.

At step 512, the system trains a machine learning model with the stored runtime variables and network requests to generate network requests with payload data for given runtime variables. For example, the generation of the network request with payload data is learned from the association with runtime variables by machine learning that allows the learned information of the association of runtime variables to persist for predicting the generation of the network request. In particular, the recurrent neural network 232 described with respect to FIG. 2 has the ability to dynamically learn from input sequential data such as runtime variables and store what has been learned to predict the generation of network requests. In embodiments, the recurrent neural network may be a standard RNN, a LSTM neural network or other type of RNN, including gated recurrent unit (GRU), trained to learn the association of runtime variables and network request with payload data. In embodiments, and as described with respect to FIG. 2, RNN training module 230 trains a machine learning model with the stored runtime variables and network requests to generate network requests with payload data for given runtime variables.

At step 514, the system generates a network request with payload data for given runtime variables using the trained machine learning model. In embodiments, and as described with respect to FIG. 2, machine learning module 228 generates a network request with payload data for given runtime variables using the trained machine learning model. In this way, the runtime variables and network requests for executions of the bot automating tasks are tracked, associated, stored and used to train a RNN for machine learning of the association of runtime variables and network requests to generate network requests from runtime variables for UI commands.

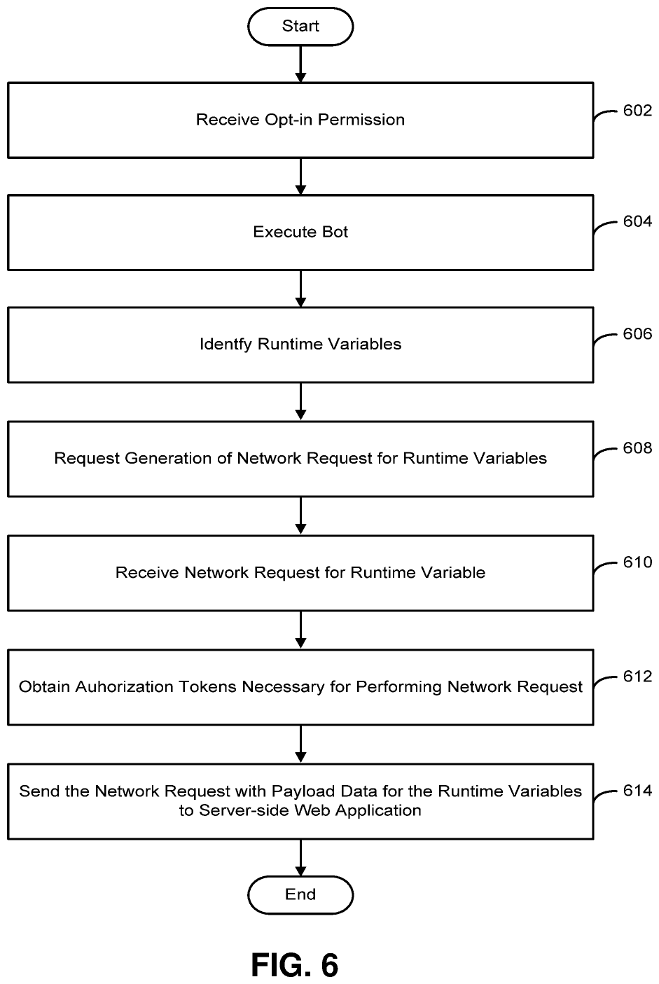

FIG. 6 shows a flowchart of an exemplary method in accordance with aspects of the present invention. Steps of the method may be carried out in the environment of FIG. 2 and are described with reference to elements depicted in FIG. 2. In particular, the flowchart of FIG. 6 shows an exemplary method for client-side acceleration of RPA tasks with machine learning generation of network requests for UI commands, in accordance with aspects of the present invention.

At step 602, the client receives opt-in permission to use the exemplary modules of the system from a user. For example, a user of client device 206 described with respect to FIG. 2 may provide opt-in permission to use the exemplary modules of the system. In embodiments, and as described with respect to FIG. 2, client device 206 receives opt-in permission to use the exemplary modules of the system from a user.

At step 604, the client executes a bot performing web-based automation. For example, the bot performing web-based automation may include in embodiments execution of UI commands that input data into a UI of client-side web application code. For instance, the input data may be the selection of a UI control such as a single select control, combo boxes, radio buttons, and other type of UI control. In embodiments, and as described with respect to FIG. 2, bot 212 executes in client memory 208 of client device 206.

At step 606, the client identifies runtime variables of the bot. For instance, the bot may be updated in embodiments to include the addition of execution code that requests generation of a network request with payload data from the system prior to executing RPA commands with parameters. As part of the execution code included in the bot that requests generation of a network request with payload data from the system prior to executing the RPA command in embodiments, the bot may identify runtime variables for the RPA commands. In embodiments, and as described with respect to FIG. 2, bot 212 executing on client device 206 identifies runtime variables of the bot.

At step 608, the client requests generation of a network request for runtime variables. For instance, bot 212 described with respect to FIG. 2 may send a request with runtime variables to the machine learning module 228 executing in server memory 222 on server 220, described with respect to FIG. 2, to generate a network request for the runtime variables. In embodiments, and as described with respect to FIG. 2, bot 212 executing on client device 206 requests generation of the network request for runtime variables.

At step 610, the client receives the network request for the runtime variables. For example, bot 212 executing on client device 206 may receive the network request generated for the runtime variables that may include as payload data, for instance, input data selecting a UI control such as a single select control, combo boxes, radio buttons, and other type of UI control. In embodiments, and as described with respect to FIG. 2, bot 212 executing on client device 206 receives the network request for the runtime variables.

At step 612, the client obtains authorization tokens necessary for performing the network request. For instance, bot 212 executing on client device 206 may log into a database that requires password access for inputting data into the database and may obtain an authorization token to accompany a request to input data into the database. In embodiments, and as described with respect to FIG. 2, bot 212 executing on client device 206 obtains authorization tokens necessary for performing the network request.

At step 614, the client sends the network request with payload data for the runtime variables to the server-side web application along with necessary authorization tokens. In embodiments, and as described with respect to FIG. 2, bot 212 executing on client device 206 sends the network request with payload data for the runtime variables to the server-side web application along with necessary authorization tokens without execution of the client-side UI command. Accordingly, the bot bypasses client-side execution of the UI command and directly sends the network request with payload data generated by a machine learning model to the web application for processing along with any necessary authorization tokens.

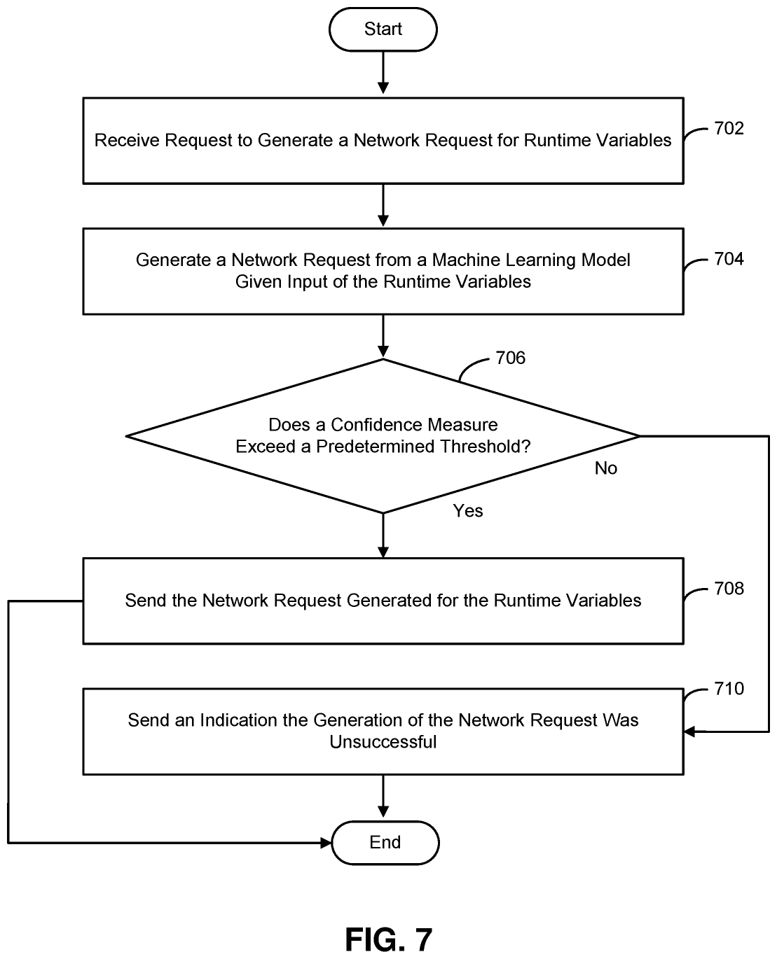

FIG. 7 shows a flowchart of an exemplary method in accordance with aspects of the present invention. Steps of the method may be carried out in the environment of FIG. 2 and are described with reference to elements depicted in FIG. 2. In particular, the flowchart of FIG. 7 shows an exemplary method for acceleration of RPA tasks with machine learning generation of network requests, in accordance with aspects of the present invention.

At step 702, the system receives a request to generate a network request for runtime variables. For instance, machine learning module 228 described with respect to FIG. 2 may receive a request with runtime variables from bot 212 executing client-side web application code in client memory 208 on client device 206, described with respect to FIG. 2. In embodiments, and as described with respect to FIG. 2, machine learning module 228 receives a request to generate a network request for runtime variables.

At step 704, the system generates a network request from a machine learning model given input of the runtime variables. For instance, the system inputs the sequence of runtime variables into a trained recurrent neural network in embodiments and the recurrent neural network generates a network request with payload data. The generated network request may be, for example, a POST HTTP requests with payload data such as input data for a UI control. In embodiments, the recurrent neural network may be a standard RNN, a LSTM neural network or other type of RNN, including gated recurrent unit (GRU), trained to learn the association of runtime variables and network request with payload data. In embodiments, and as described with respect to FIG. 2, machine learning module 228 inputs the runtime variables into the recurrent neural network 232 which outputs a generated network request for the runtime variables.

At step 706, the system determines whether a confidence measure in the output of the generated network request exceeds a predetermined threshold. For instance, the recurrent neural network 232 described with respect to FIG. 2 may provide a probability in embodiments that the runtime variables input into the trained recurrent neural network predict the output sequence of the network request with payload data generated by the recurrent neural network. If the confidence measure exceeds the predetermined threshold, then the system may send the output sequence of the network request with payload data generated by the recurrent neural network to the bot to bypass execution of the UI commands and accelerate automation of the tasks. Otherwise, the bot may execute the UI command which will generate and send the network request with payload data to the web application for processing. Accordingly, if it is determined that the confidence measure exceeds the predetermined threshold, carrying out steps of the exemplary method continue at step 712. Otherwise, if it is determined that the confidence measure does not exceed the predetermined threshold, carrying out the steps of the exemplary method continue at step 710. In embodiments, and as described with respect to FIG. 2, machine learning module 228 determines whether a confidence measure in the output of generated network request exceeds a predetermined threshold.

At step 708, the system sends the generated network request for runtime variables in response to the request. For instance, machine learning module 228 described with respect to FIG. 2 may send the generated network request with payload data generated by the recurrent neural network to bot 212 that may bypass client-side execution of a UI command and directly send the network request with payload data generated by a machine learning model to the web application for processing. In embodiments, and as described with respect to FIG. 2, machine learning module 228 sends the generated network request for runtime variables in response to the request.

At step 710, the system sends an indication that the generation of the network request was unsuccessful if it was determined that the confidence measure did not exceed the predetermined threshold at step 706. In embodiments, and as described with respect to FIG. 2, machine learning module 228 sends the indication that the generation of the network request was unsuccessful. For example, machine learning module 228 described with respect to FIG. 2 may send the indication that the generation of the network request was unsuccessful in response to a request from bot 212, and bot 212 may not bypass client-side execution of a UI command in embodiments but instead execute the UI command which will generate and send the network request with payload data to the web application for processing.

In this way, embodiments of the present disclosure train a machine learning model to learn the association of runtime variables and network request to accelerate RPA tasks. Advantageously, embodiments of the present disclosure accelerate automation of RPA tasks by generating network requests that can be sent to a web application for processing without the need to execute RPA commands such as UI commands.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a processor, plural runtime variables of a bot executing client-side web application code;
generating, by the processor, a network request from a machine learning model given input of the plural runtime variables of the bot; and
sending, by the processor, the network request generated from the machine learning model to the bot.

2. The computer-implemented method of claim 1, further comprising:
inputting the plural runtime variables of the bot into the machine learning model; and
receiving output of the generated network request from the machine learning model.

3. The computer-implemented method of claim 2, further comprising determining if a confidence measure in the output of the generated network request exceeds a predetermined threshold.

4. The computer-implemented method of claim 1, wherein the machine learning model comprises a recurrent neural network trained with plural associations of runtime variables and network requests to a web application.

5. The computer-implemented method of claim 1, wherein the machine learning model comprises a Long Short Term Memory (LSTM) neural network trained with plural associations of runtime variables and network requests to a web application.

6. The computer-implemented method of claim 1, wherein the machine learning model comprises a Gated Recurrent Unit (GRU) neural network trained with plural associations of runtime variables and network requests to a web application.

7. The computer-implemented method of claim 1, wherein at least one of the plural runtime variables of the bot comprises a parameter of a robotic process automation command.

8. The computer-implemented method of claim 1, wherein the network request comprises a hypertext transfer protocol request with payload data of a selection of a user interface control in the client-side web application code.

9. The computer-implemented method of claim 1, further comprising receiving a request for generation of the network request from the bot executing client-side web application code.

10. The computer-implemented method of claim 1, further comprising storing the association of the plural runtime variables of the bot and the network request in persistent storage.

11. A computer program product comprising one or more computer readable storage media having program instructions collectively stored on the one or more computer readable storage media, the program instructions executable to:
receive runtime variables from executions of at least one bot executing client-side web application code;
receive network requests from the executions of the at least one bot executing client-side web application code;
store plural associations of the runtime variables and the network requests; and
train a machine learning model with the plural associations of the runtime variables and the network requests to generate a network request given input of runtime variables from an executing bot.

12. The computer program product of claim 11, wherein at least one of the runtime variables from the executing bot comprises a parameter of a robotic process automation command.

13. The computer program product of claim 11, wherein at least one of the network requests comprises a hypertext transfer protocol request with payload data of a selection of a user interface control in the client-side web application code.

14. The computer program product of claim 11, wherein the machine learning model is selected from the group consisting of a recurrent neural network, a Long Short Term Memory (LSTM) neural network, and a Gated Recurrent Unit (GRU) neural network.

15. A system comprising:
a processor set, one or more computer readable storage media, and program instructions collectively stored on the one or more computer readable storage media, the program instructions executable to:
receive opt-in permission from a user of a client device;
request generation of a network request from runtime variables of a bot executing client-side web application code of a web application;
receive the network request generated from a machine learning model given input of the runtime variables of the bot; and
send the network request to the web application for processing.

16. The system of claim 15, wherein the sending the network request comprises bypassing execution of a robotic process automation command.

17. The system of claim 15, wherein the program instructions are further executable to identify the runtime variables of the bot.

18. The system of claim 15, wherein the machine learning model is trained with plural associations of runtime variables and network requests to generate the network request given input of the runtime variables of the bot.

19. The system of claim 15, wherein the machine learning model comprises a recurrent neural network trained with plural associations of runtime variables and network requests to the web application.

20. The system of claim 15, wherein the program instructions are further executable to track plural network requests from client-side web application code sent to the web application.
